(19) United States
(12) Patent Application Publication
(10) Pub. No.: US 2026/0310212 A1
(43) Pub. Date: Oct. 8, 2026

(54) SYSTEMS AND METHODS FOR SEMANTICALLY-AWARE NAVIGATION

(71) Applicant: ROCKWELL AUTOMATION CANADA LTD., Cambridge (CA)

(72) Inventors: Nolan LUNSCHER, Kitchener (CA); Krispin Alexander DAVIES, Kitchener (CA); Syeda Mariam AHMED, Waterloo (CA); Ivor WANDERS, Kitchener (CA); Enrique FERNÁNDEZ PERDOMO, Girona (ES); Marco PICCINELLI, Kitchener (CA); Omar Serag Mohamed Serag ELMOFTY, Cambridge (CA); Guillaume Michel AUTRAN, Waterloo (CA); Jason MERCER, Kitchener (CA); Joao Ricardo MACHADO, Woodstock (CA); Robert BRADFORD, Ajax (CA); Ryan Christopher GARIEPY, Waterloo (CA)

(21) Appl. No.: 19/173,513

(22) Filed: Apr. 8, 2025

(51) Int. Cl. G05D 1/617; G05D 1/2285; G05D 1/246; G05D 1/656; G05D 105/28

(52) U.S. Cl. CPC G05D 1/617; G05D 1/2285; G05D 1/246; G05D 1/656; G05D 2105/28

(57) ABSTRACT

Various embodiments of an autonomous mobile robot operable within a facility and methods of operating the autonomous mobile robot are described herein. The autonomous mobile robot includes one or more sensors configured to collect environmental data characterizing an environment of the autonomous mobile robot and receive user prompts representative of mission instructions. The user prompts include natural directions. The autonomous mobile robot also includes one or more processors, which are configured to determine an operational purpose of the autonomous mobile robot, initiate a planning component to evaluate the user prompts to define a mission goal for the autonomous mobile robot with reference to the operational purpose of the autonomous mobile robot and the environmental data and generate a mission plan for accomplishing the mission goal. The processor(s) then initiate an execution component functionally separate from the planning component to operate the autonomous mobile robot to execute the mission plan.

### FIELD

The described embodiments relate to systems and methods for operating semantically-aware autonomous mobile robots.

### BACKGROUND

Robots that can navigate within a constrained environment and perform tasks without constant human oversight are commonplace in industrial environments. These mobile robots can rely on guidance devices and travel along predetermined routes or can be autonomous and capable of navigating without the aid of guidance devices. These autonomous mobile robots typically rely on sensors and a map of the environment to navigate to specific locations within the environment.

Typically, operators provide instructions to robots in the form of a sequence of specific steps, including specific waypoint and/or destination coordinates. The specific steps can vary, depending on the pre-defined capabilities of each robot and the capabilities of the user interface presented to the operator. In order to provide these specific instructions, a given operator must be trained on the capabilities of each robot that the operator engages with, the types of missions that each robot can perform and the steps that can be taken by each robot. Training operators can be time-consuming and impractical, given the range of capabilities of different robots and the diversity in operating environments.

In addition, conventional mobile robots are typically restricted in their ability to adapt to changing environments, due to the specific steps that must be provided to the mobile robots.

### SUMMARY

The various embodiments described herein generally relate to autonomous mobile robots capable of semantically-aware navigation and methods of operating thereof.

In accordance with an example embodiment, there is provided an autonomous mobile robot operable within a facility. The autonomous mobile robot comprises one or more sensors configured to: collect environmental data characterizing an environment of the autonomous mobile robot; and receive user prompts representative of mission instructions, the user prompts comprising natural directions; and one or more processors in communication with the one or more sensors. The one or more processors are configured to: determine an operational purpose of the autonomous mobile robot; initiate a planning component to: evaluate the user prompts to define a mission goal for the autonomous mobile robot with reference to the operational purpose of the autonomous mobile robot and the environmental data; and generate a mission plan for accomplishing the mission goal, the mission plan defining a path for the autonomous mobile robot; and initiate an execution component functionally separate from the planning component to operate the autonomous mobile robot to execute the mission plan.

In some embodiments, the plurality of sensors are configured to continuously monitor the environmental data and the one or more processors are configured to: initiate an execution monitoring component to, while the autonomous mobile robot is operating to execute the mission plan: determine an expected mission state based on the mission plan; and evaluate a current mission state of the autonomous mobile robot based on the environmental data; and in response to determining the current mission state differs from the expected mission state, transmit a request for an updated mission plan, wherein the planning component is configured to generate the updated mission plan for accomplishing the mission goal, based on the environmental data.

In some embodiments, the user prompts comprise one or more of: verbal instructions, visual instructions, and a demonstration.

In some embodiments, the operational purpose comprises one or more of: operational constraints of the autonomous mobile robot, skills performable by the autonomous mobile robot, actions performable by the autonomous mobile robot, previously generated mission plans and pre-configured mission plans.

In some embodiments, the one or more processors are configured to: retrieve an electronic map of the facility characterizing previous environmental data; and generate the mission plan based on the electronic map.

In some embodiments, the one or more processors are configured to: in response to determining insufficient information is available to generate a mission plan, generate a natural request for additional information.

In some embodiments, the one or more processors are configured to: generate a natural language robot response describing the mission plan.

In some embodiments, the autonomous mobile robot comprises a digital screen configured to display an electronic map of the facility indicating one or more of: the path of the autonomous mobile robot and objects of interest along the path of the autonomous mobile robot.

In some embodiments, the one or more processors are configured to, while the autonomous mobile robot is executing the mission plan: identify future mission conflicts between the mission plan of the autonomous mobile robot and a mission plan of another actor within the facility based on the environmental data; determine a priority of the mission goal associated with the mission plan of the other actor, relative to a priority of the mission goal of the autonomous mobile robot; and determine a course of action, based on the priority of the mission goal of the other actor relative to the priority of the mission goal of the autonomous mobile robot.

In some embodiments, the course of action is one of: requesting an updated mission plan, continuing execution of the mission plan and pausing execution of the mission plan.

In accordance with another example embodiment, there is provided a method of operating an autonomous mobile robot comprising one or more sensors. The method involves: collecting, by the sensors, environmental data characterizing an environment of the autonomous mobile robot; receiving, by the sensors, user prompts representative of mission instructions, the user prompts comprising natural directions; and operating one or more processors to: determine an operational purpose of the autonomous mobile robot; initiate a planning component to: evaluate the user prompts to define a mission goal for the autonomous mobile robot with reference to the operational purpose of the autonomous mobile robot and the environmental data; and generate a mission plan for accomplishing the mission goal, the mission plan defining a path for the autonomous mobile robot; and initiate an execution component functionally separate from the planning component to operate the autonomous mobile robot to execute the mission plan.

In some embodiments, the method further comprises continuously monitoring, by the sensors, the environmental data and operating the one or more processors to: initiate an execution monitoring component to, while the autonomous mobile robot is operating to execute the mission plan: determine an expected mission state based on the mission plan; and evaluate a current mission state of the autonomous mobile robot based on the environmental data; in response to determining the current mission state differs from the expected mission state, transmit a request for an updated mission plan, and the planning component is configured to generate the updated mission plan for accomplishing the mission goal, based on the environmental data.

In some embodiments, the user prompts comprise one or more of: verbal instructions, visual instructions, and a demonstration.

In some embodiments, the operational purpose comprises one or more of: operational constraints of the autonomous mobile robot, skills performable by the autonomous mobile robot, actions performable by the autonomous mobile robot, previously generated mission plans and pre-configured mission plans.

In some embodiments, the method further comprises operating the one or more processors to: retrieve a facility map of the facility characterizing previous environmental data; and generate the mission plan based on the facility map.

In some embodiments, the method further comprises operating the one or more processors to: in response to determining insufficient information is available to generate a mission plan, generate a natural request for additional information.

In some embodiments, the method further comprises operating the one or more processors to: generate a natural language robot response describing the mission plan.

In some embodiments, the autonomous mobile robot comprises a digital screen and the method comprises configuring the digital screen to display an electronic map of the facility indicating one or more of: the path of the autonomous mobile robot and objects of interest along the path of the autonomous mobile robot.

In some embodiments, the method further comprises operating the one or more processors to, while the autonomous mobile robot is executing the mission plan: identify future mission conflicts between the mission plan of the autonomous mobile robot and a mission plan of another actor within the facility based on the environmental data; determine a priority of the mission goal associated with the mission plan of the other actor, relative to a priority of the mission goal of the autonomous mobile robot; and determine a course of action, based on the priority of the mission goal of the other actor relative to the priority of the mission goal of the autonomous mobile robot.

In some embodiments, the course of action is one of: requesting an updated mission plan, continuing execution of the mission plan and pausing execution of the mission plan.

### BRIEF DESCRIPTION OF THE DRAWINGS

Several embodiments will now be described in detail with reference to the drawings, in which:

FIG. 1 is a block diagram of an autonomous mobile robot in communication with external components, in accordance with an example embodiment;

FIG. 2 is a block diagram of example components of an example autonomous mobile robot;

FIG. 3 is another block diagram of example components of the autonomous mobile robot of FIG. 2;

FIG. 4 is a flow diagram of an example method for operating a semantically-aware autonomous mobile robot, in accordance with an example embodiment;

FIG. 5 is a flow diagram of an example method for monitoring the execution of a mission plan, in accordance with an example embodiment;

FIG. 6 is a schematic diagram showing an example of the operation of a semantically-aware autonomous mobile robot, in accordance with an example embodiment;

FIG. 7 is a schematic diagram showing another example of the operation of a semantically-aware autonomous mobile robot, in accordance with an example embodiment;

FIG. 8 is a schematic diagram showing another example of the operation of a semantically-aware autonomous mobile robot, in accordance with an example embodiment; and

FIG. 9 is a schematic diagram showing another example operation of a semantically-aware autonomous mobile robot, in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to semantically-aware autonomous mobile robots. It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

Conventional autonomous mobile robots are usually given missions in the form of a sequence of specific steps. A conventional autonomous mobile robot can for example, be instructed to travel to coordinates (X₁, Y₁), proceed to dock at a pick up and drop off (P&D) stand located at coordinates (X₂, Y₂) and then lift off a payload off the stand. These steps are typically selected by an operator, from a list and typically require the operator to know the capabilities of the autonomous mobile robot, and have detailed knowledge of the layout of the facility in which the autonomous mobile robot operates. The autonomous mobile robot can then plan a path to travel to the specified coordinates or receive a path from the operator.

Some autonomous mobile robots can be capable of dynamically planning a path, in response to receiving destination coordinates and navigate around obstacles. For example, some autonomous mobile robots can have collision avoidance capabilities. However, conventional autonomous mobile robots'ability to respond to changes in the environment or unexpected objects in the environment is often limited, causing missions to be frequently aborted.

Typically, when any step of a mission cannot be completed by a conventional autonomous mobile robot, the entire mission typically fails and/or human intervention is required to move the robot and restart the mission.

The autonomous mobile robots described herein can generate mission plans without the need to receive a sequence of specific steps from an operator. The autonomous mobile robots described herein can be described as “semantically-aware”, due to their ability to understand the meaning and context of information. The autonomous mobile robots described can generate mission plans using semantic contextual information characterizing the environment of the autonomous mobile robot and open-ended user prompts in the form of natural language (e.g., spoken, written), visual instructions and/or demonstrations and knowledge of their operational purpose. The autonomous mobile robots described can build a contextual understanding of their mission goals and environments to generate open-ended mission plans.

In addition, the autonomous mobile robots described can update mission plans, once execution of a mission has begun and can dynamically adapt to changes in the environment. The autonomous mobile robots described can monitor their environment during execution of a mission and generate updated mission plans when their current mission state differs from an expected mission state. The autonomous mobile robots described can accordingly successfully complete more missions, when compared to conventional autonomous mobile robots.

The autonomous mobile robots described can employ a collection of deep learning models, such as large language models (LLMs), audio-language models (ALMs) and/or visual language models (VLMs) that are trained to understand natural language, auditive information and/or visual information and generate natural language.

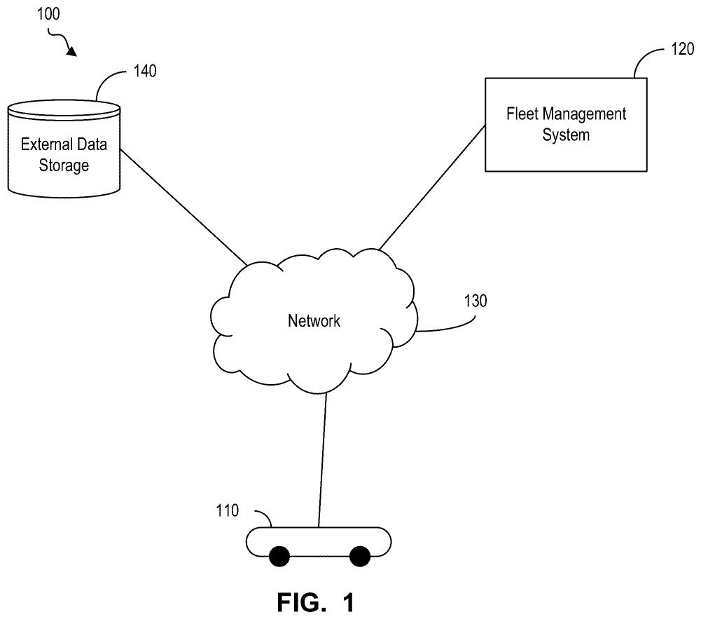

Referring now to FIG. 1, shown therein a block diagram 100 illustrating an example autonomous mobile robot 110 in communication with example external components. As shown in FIG. 1, the autonomous mobile robot 110 can be in communication with a fleet management system 120 and an external data storage 140 via a network 130. The autonomous mobile robots 110 can operate to pick up, transport, and/or drop off materials at various locations.

The network 130 may be any network capable of carrying data, including the Internet, Ethernet, old telephone service (POTS) line, public switch telephone network (PSTN), integrated services digital network (ISDN), digital subscriber line (DSL), coaxial cable, fiber optics, satellite, mobile, wireless (e.g. Wi-Fi™, WiMAX®), Signaling System 7 (SS7) network, fixed line, local area network (LAN), wide area network (WAN), and others, including any combination of these, capable of interfacing with, and enabling communication between the autonomous mobile robots 110, the fleet management system 120 and/or the external data storage 140. In some embodiments, the autonomous mobile robot 110 can communicate with other robots via the network 130. In some embodiments, the autonomous mobile robot 110 can communicate with other autonomous mobile robots directly via onboard communication components.

The external data storage 140 can store data related to the autonomous mobile robot 110. The external data storage 140 can include RAM, ROM, one or more hard drives, one or more flash drives or some other suitable data storage elements such as disk drives, etc.

The external data storage 140 can also store electronic maps related to the operating environment of the autonomous mobile robot 110. The electronic maps located on external data storage 140 can be accessible for download, via the network 130, by the fleet management system 120 and the autonomous mobile robot 110. The electronic maps can characterize the facility in which the autonomous mobile robot operates, for example, traversable areas of the facility, traffic rules within the facility, points of interest within the facility, etc., which may be predetermined and/or learned by autonomous mobile robots 110. The electronic map can be semantically embedded. In some embodiments, the electronic map can be generated and updated by the fleet management system 120 based on information received from autonomous mobile robots 110. In some embodiments, the external data storage 140 can be located at the fleet management system 120. The external data storage 140 can also store previously generated missions or pre-configured missions for autonomous mobile robots 110. In some embodiments, the external data storage 140 can also store operational purposes of various autonomous mobile robots 110 within a fleet.

In some embodiments, the mobile robot 110 can be in communication with a fleet management system 120. The illustrated FIG. 1 includes the fleet management system 120. The fleet management system 120 can operate to direct and/or monitor the operation of the autonomous mobile robot 110 and provide software updates to the autonomous mobile robot 110. In some embodiments, the fleet management system 120 can transmit fleet-orchestrated missions to the autonomous mobile robot 110. In some embodiments, the autonomous mobile robot 110 can operate within a decentralized network-without, or at least with minimal, involvement of the fleet management system 120.

The fleet management system 120 can include a processor, a data storage, and a communication component (not shown). For example, the fleet management system 120 can be any computing device, such as, but not limited to, an electronic tablet device, a personal computer, workstation, server, portable computer, mobile device, personal digital assistant, laptop, smart phone, WAP phone, an interactive television, video display terminals, gaming consoles, and portable electronic devices or any combination of these. The components of the fleet management system 120 can be provided over a wide geographic area and connected via the network 130. The fleet management system 120 can include components that enable a user to interact with the fleet management system 120 and autonomous mobile robots 110 managed by the fleet management system 120.

In some embodiments, the fleet management system 120 can transmit information about one or more other autonomous mobile robots 110 to the autonomous mobile robot 110 and/or about the environment of the autonomous mobile robot 110. For example, the fleet management system 120 can transmit information about other autonomous mobile robots' 110 paths, other autonomous mobile robots 110 or other obstacles outside the field of view of the autonomous mobile robot 110, or missions executed by other autonomous mobile robots 110.

The fleet management system 120 can also receive data from the autonomous mobile robot 110. For example, the autonomous mobile robot 110 can transmit operating data about objects or landmarks identified during its operation that appear inconsistent with the electronic map. The fleet management system 120 can receive the operating data and update the electronic map, as necessary.

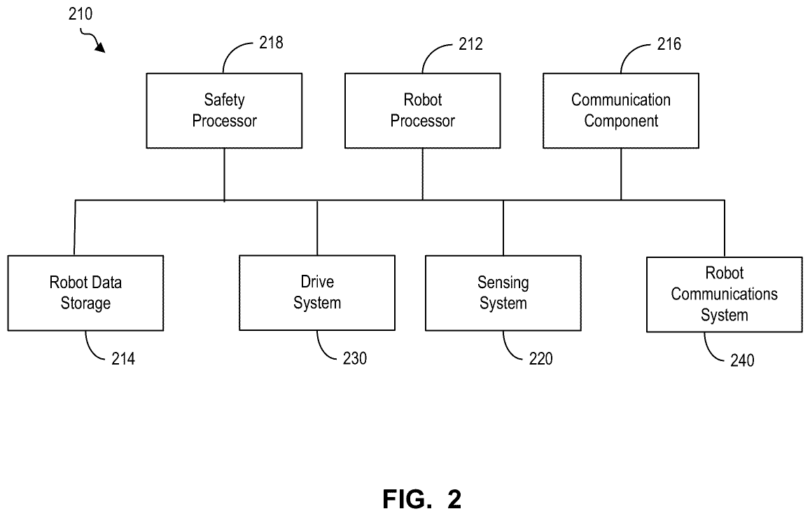

Reference is next made to FIG. 2, which illustrates a schematic diagram showing an example embodiment of an autonomous mobile robot 210. Specifically, autonomous mobile robot 210 can act as an autonomous robot for transporting objects between different locations. The autonomous mobile robot 210 can include a cargo component for carrying loads. For example, the cargo component can be a flatbed or a bucket having sidewalls to prevent loads from falling out as the autonomous mobile robot 210 moves. The cargo component can extend over the sides of the autonomous mobile robot 210 (i.e., the cargo component can have a larger footprint than the autonomous mobile robot 210). The autonomous mobile robot 210 can include cargo securing mechanisms to secure the load and prevent the load from falling off the autonomous mobile robot 210. The autonomous mobile robot 210 can include flexible components, which may be removed from the autonomous mobile robot 210. For example, a cargo securing mechanism may be removable when not in use. Although the autonomous mobile robot 210 can act as a transport robot, the autonomous mobile robot 210 is not limited to transporting objects.

The autonomous mobile robot 210 can include a robot processor 212, a vehicle data storage 214, a communication component 216, a safety processor 218, a sensing system 220, a drive system 230 and a robot communications system 240. In some embodiments, one or more of the components 212, 214, 216, 218, 220, 230 and 240 can be combined into fewer components, or separated into further components. For example, the robot processor 212 and the safety processor 218 can be combined in the same component. In some embodiments, parts of a component can be combined with another part of another component.

The robot processor 212 and the safety processor 218 can each include any suitable processor, controller or digital signal processor that can provide sufficient processing power and reliability depending on the configuration, purposes and requirements of the autonomous mobile robot 210. In some embodiments, the robot processor 212 and the safety processor 218 can each include more than one processor with each processor being configured to perform different dedicated tasks.

The robot processor 212 may be operable to navigate the autonomous mobile robot 210 in response to one or more of: a navigation command and an operational signal. The autonomous mobile robot 210 may be an autonomous mobile robot 110. The navigation command may be a command to navigate the autonomous mobile robot 210 to a specified waypoint. The operational signal may, in some instances, be a command to stop or slow the autonomous mobile robot 210 or to perform an action. The robot processor 212 can initiate a planning component, an execution component and an execution monitoring component. At least the planning component and the execution component can be functionally separate. The robot processor 212 can initiate the planning component to define a mission goal for the autonomous mobile robot 210 and to generate a mission plan for the autonomous mobile robot 210. The robot processor 212 can initiate the execution component to operate the autonomous mobile robot 210 to execute the mission plan. The execution component can generate a navigation command and/or an operation signal. The robot processor 212 can monitor the execution of the mission plan via the execution monitoring component. In some embodiments, the execution component and the execution monitoring component can be implemented by the same component.

The robot processor 212 and the safety processor 218 can each operate the vehicle data storage 214, the communication component 216, the sensing system 220, the drive system 230 and the robot communications system 240. For example, the robot processor 212 and the safety processor 218 can each operate the drive system 230 to navigate to the waypoints or destination location. The robot processor 212 and the safety processor 218 can each also operate the drive system 230 to avoid collisions with objects detected in the autonomous mobile robot's proximity and bring the autonomous mobile robot to a stop, or rest position when appropriate. The safety processor 218 can operate the robot communications system 240 to generate messages (e.g., visual messages, auditive messages). The operation of the robot processor 212 and the safety processor 218 can each be based on data collected from the robot data storage 214, the communication component 216, the sensing system 220, and/or the drive system 230, in some embodiments.

Given waypoints or a destination location, the robot processor 212 can determine a trajectory to the destination location. A trajectory can be defined as a time-parameterized path and a path can be defined based on a series of positions, which may or may not include headings. Different trajectories can relate to the same path as an autonomous mobile robot may follow the same path but at different speeds.

The vehicle data storage 214 can include RAM, ROM, one or more hard drives, one or more flash drives or some other suitable data storage elements such as disk drives, etc. For example, the robot data storage 214 can include volatile and non-volatile memory. Non-volatile memory can store computer programs consisting of computer-executable instructions, which can be loaded into the volatile memory for execution by the robot processor 212 or the safety processor 218. Operating the robot processor 212 to carry out a function can involve executing instructions (e.g., a software program) that can be stored in the vehicle data storage 214 and/or transmitting or receiving inputs and outputs via the communication component 216. The vehicle data storage 214 can also store data input to, or output from, the robot processor 212 or the safety processor 218, which can result from the course of executing the computer-executable instructions for example.

In some embodiments, the vehicle data storage 214 can store data related to the operation of the autonomous mobile robot 210, such as one or more electronic maps of its operating environment, operating parameters and/or operational constraints of the autonomous mobile robot 210. The vehicle data storage 214 can store data tables, data processing algorithms (e.g., image processing algorithms), models for extracting semantically grounded embeddings from information received by the autonomous mobile robot 210, models for converting information into a specific representation (e.g., tokens, domain-specific language, programming language), models for interpreting language (e.g., large language models (LLMs), audio-language models (ALMs), visual language models (VLMs)) as well as other data and/or operating instructions which can be used by the robot processor 212 or the safety processor 218. The robot processor 212 and the safety processor 218 can each operate to process data received from the sensing system 220.

The communication component 216 can include any interface that enables the autonomous mobile robot 210 to communicate with other components, external devices and systems and other autonomous mobile robots 210.

In some embodiments, the communication component 216 can include at least one of a serial port, a parallel port or a USB port. The communication component 216 may also include a wireless transmitter, receiver, or transceiver for communicating with a wireless communications network (e.g., using an IEEE 802.11 protocol or similar) over a wider area than the short-range wireless communication protocol used for communicating information between autonomous mobile robots 210. The wireless communications network can include at least one of an Internet, Local Area Network (LAN), Ethernet, Bluetooth, Bluetooth Mesh and can be used by the autonomous mobile robot 210 to communicate with a fleet management system (not shown) and/or to communicate information to other autonomous mobile robots 210.

Various combinations of these elements may be incorporated within the communication component 216. For example, the communication component 216 may also be used to receive input from various input devices, such as a mouse, a keyboard, a touch screen, a thumbwheel, a track-pad, a track-ball, a card-reader, voice recognition software and the like depending on the requirements and implementation of the autonomous mobile robot 210. For example, the communication component 216 can receive commands and/or data from the fleet management system 120.

The communication component 216 can receive information about obstacles and/or unexpected objects located in the autonomous mobile robot's operating environment directly from other autonomous mobile robots within the same operating environment and/or indirectly via a fleet management system. The robot processor 212 can update an electronic map stored in the vehicle data storage 214 with this information, for example. The robot processor 212 may also transmit, via the communication component 216 for example, information related to obstacles and/or unexpected objects identified in its operating environment to other autonomous mobile robots directly or indirectly via the fleet management system.

The sensing system 220 can monitor the environment of the autonomous mobile robot 210. The sensing system 220 can include one or more vehicle sensors for capturing information related to the environment (i.e., environmental data) and for receiving user prompts indicative of mission instructions. The information captured by the sensing system 220 can be applied for various purposes, such as localization, navigation, defining a mission goal, mapping and/or collision avoidance. For example, the sensing system 220 can include optical sensors equipped with depth perception capabilities, infrared (IR) capabilities, or sonar capabilities. The optical sensors can include imaging sensors (e.g., photographic and/or video cameras), and range-finding sensors (e.g., time of flight sensors, Light Detection and Ranging (LiDAR) devices which generate and detect reflections of pulsed laser from objects proximal to the autonomous mobile robot 210, radars, etc.). The sensing system 220 can also include acoustic sensors, such as microphones, that can detect and record sounds. The sensing system 220 can also include navigational sensors, such as global positioning system (GPS) sensors, inertial measurement sensors, as well as sensors that detect guiding infrastructure installed within the operating environment. Example sensors that detect guiding infrastructure can include, but not limited to, magnetic sensors that detect magnetic tape within a facility warehouse, and/or optical sensors that detect visual navigational indicators within the operating environment. The sensing system 220 can include proximity sensors that detect people or objects within a proximity of the autonomous mobile robot 210.

The sensing system 220 can also monitor the operation of the autonomous mobile robot 210. The sensing system 220 can include example sensors, such as encoders, arranged to measure the speed of a wheel of the autonomous mobile robot 210, the traction of the autonomous mobile robot 210, or the tilt angle of the autonomous mobile robot 210. In some embodiments, encoders are provided for each wheel. On tricycle autonomous mobile robots, encoders can measure the steering angle along with the drive velocity. The sensing system 220 can include sensors to measure the presence, the mass, or the type of a payload of the autonomous mobile robot 210.

The sensing system 220 can include a vehicle odometry system to monitor continuous variables and/or discrete variables. For example, continuous variables can relate to speed, velocity, traction, steering angle, tilt angle, and/or payload mass measurements while discrete variables can relate to the presence of a payload, the type of payload, and/or the presence of a human within a proximity of the autonomous mobile robot 210.

The sensing system 220 can include one or more components that control the operation of the sensors. For example, the components can include, but are not limited to, one or more processors, programmable logic controllers (PLCs), motor contactors, and/or relays. In some embodiments, the sensing processors can receive data collected by the sensors and process the collected data. The sensing processors can operate independently from the robot processor 212 and the safety processor 218. In some embodiments, the sensing system 220 can receive the data collected by the sensors and transmit the collected data to the robot processor 212 and the safety processor 218 for processing. In other embodiments, the sensing system 220 can directly incorporate functionality from the safety processor 218.

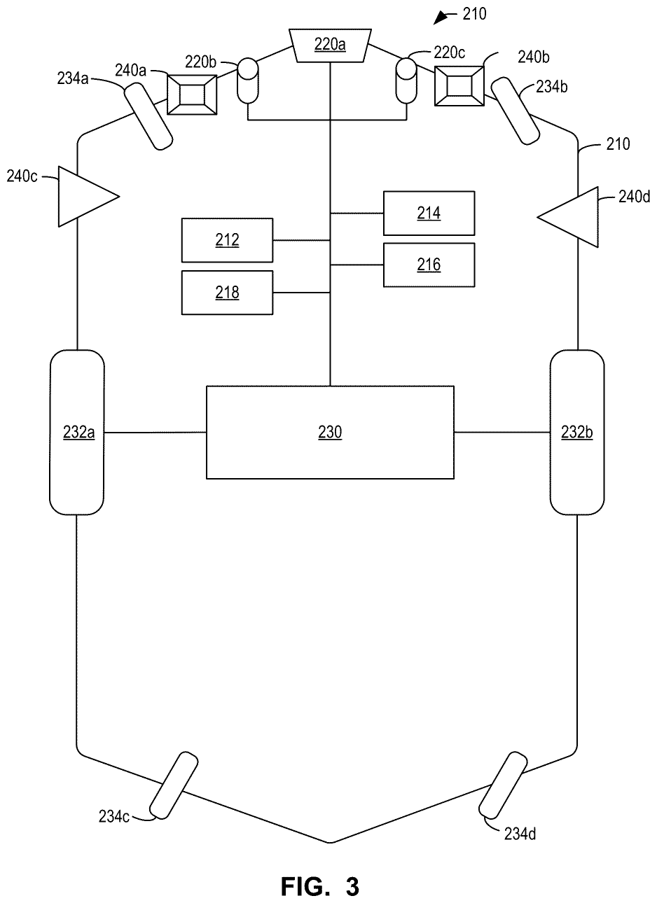

The drive system 230 can include the components required for steering and driving the autonomous mobile robot 210. For example, the drive system 230 can include the steering component and drive motor. Specifically, the drive system 230 may include a motor and/or brakes connected to drive wheels 232a and 232b for driving the autonomous mobile robot 210, as shown in FIG. 3. The motor can be, but is not limited to, an electric motor, a combustion engine, or a combination/hybrid thereof. Depending on the application of the autonomous mobile robot 210, the drive system 230 may also include control interfaces that can be used for controlling the drive system 230. For example, the drive system 230 may be controlled to drive the drive wheel 232a at a different speed than the drive wheel 232b in order to turn the autonomous mobile robot 210. Different embodiments may use different numbers of drive wheels, such as two, three, four, etc.

As shown in FIG. 3, a number of additional wheels 234 may be included. The autonomous mobile robot 210 includes wheels 234a, 234b, 234c, and 234d. The wheels 234 may be wheels that are capable of allowing the autonomous mobile robot 210 to turn, such as casters, omni-directional wheels, and mecanum wheels. In some embodiments, the autonomous mobile robot 210 can be equipped with special tires for rugged surfaces or particular floor surfaces unique to its environment.

The sensing system 220 in FIG. 2 includes example vehicle sensors 220a, 220b, and 220c, as shown in FIG. 3. The sensors 220a, 220b, 220c can include, but are not limited to, optical sensors arranged to provide three-dimensional (e.g., binocular or RGB-D) imaging, two-dimensional laser scanners, and three-dimensional laser scanner.

The robot communications system 240 can include components that can generate visual and/or auditive notifications to enable the autonomous mobile robot 210 to notify human operators or other autonomous mobile robots 210 of the intentions of the autonomous mobile robot 210. For example, the robot communications system 240 can include single lights, light arrays, light sensors, speakers, scent generators, and/or digital screens capable of displaying text or images.

The positions of the components 234, 220, 240, 230, 232, 240 of the autonomous mobile robot 210 is shown for illustrative purposes and are not limited to the illustrated positions. Other configurations of the components 234, 220, 240, 230, 232 can be used depending on the application of the autonomous mobile robot 210 and/or the environment in which the autonomous mobile robot 210 will be used.

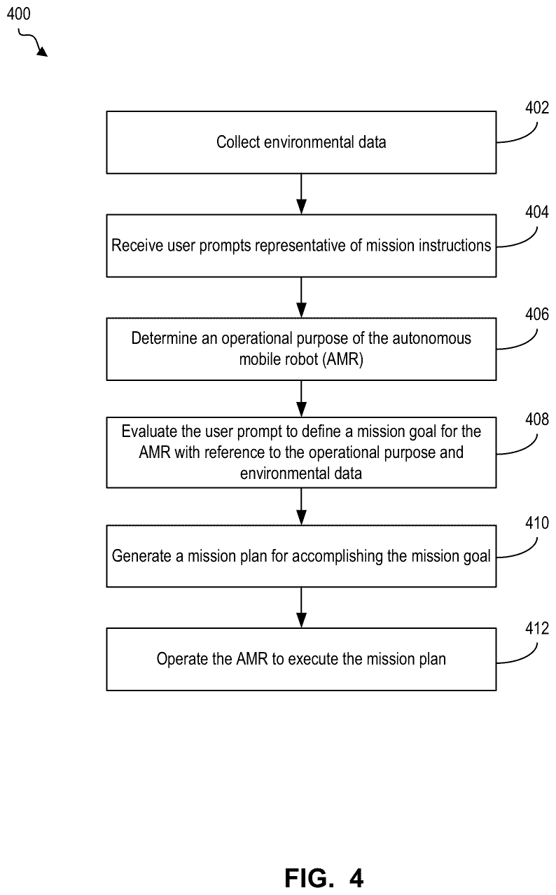

Referring next to FIG. 4, shown therein is a flowchart illustrating a method 400 of operating an autonomous mobile robot, such as autonomous robot 210 within a facility.

At 402, the sensors of the autonomous mobile robot 210 collect environmental data characterizing the environment of the autonomous mobile robot 210. By collecting environmental data, the autonomous mobile robot 210 can learn about the environment in which the autonomous mobile robot 210 is located. The autonomous mobile robot 210 can continuously collect environmental data or can collect environmental data at fixed intervals of time.

The autonomous mobile robot 210 can process the environmental data collected. For example, the autonomous mobile robot 210 can process the environmental data using one or more domain-specific encoding model(s) to obtain semantic embeddings of the environmental data.

At 404, the autonomous mobile robot 210 receives user prompts representative of mission instructions, that is, the user prompts can indicate a mission for the autonomous mobile robot 210. For example, the sensors of the autonomous mobile robot 201 can be configured to detect and receive user prompts. The user prompts instructions include natural, non-technical instructions (i.e., non-computer instructions). Natural instructions can include written or spoken (verbal) instructions expressed in natural language, gestures (e.g., pointing), a demonstration (e.g., on the autonomous mobile robot 210 through teleoperation, external demonstration), or any combination of these. For example, the user prompts can include verbal or written instructions given by a human operator. An example user prompt given by a human operator can be “Go pick up the payload closest to the wall”. Verbal or written instructions can indicate a new mission for the autonomous mobile robot 210 or can refer to missions previously performed by the autonomous mobile robot 210 (e.g., “Repeat your last mission one more time”). Verbal or written instructions can include semantic references (e.g., signage, landmark objects). A demonstration can indicate the manner in which a task is to be performed, for example, a specific manner in which a payload is to be picked up. A demonstration can be performed on the autonomous mobile robot 210, by another autonomous mobile robot 210 or by another equipment (e.g., a forklift). For example, an operator may teleoperate the autonomous mobile robot 210 to demonstrate how the autonomous mobile robot 210 is to pick up a payload and the autonomous mobile robot 210 can record, in memory, the sequence of movements.

In some embodiments, the autonomous mobile robot 210 can use a microphone to detect spoken instructions and use a speech to text algorithm (e.g., an ALM) to convert the spoken instructions into text. Alternatively, or in addition thereto, the autonomous mobile robot 210 can use one or more cameras and/or LIDAR(s) to detect gestures or an external demonstration made by an operator or a machine. In such cases, the autonomous mobile robot 210 can implement a visual interpreter model, for example, a visual language model (VLM) to interpret the gestures/demonstration and transform the interpretation into text. The VLM can be any model capable of interpreting visual information and transforming the visual interpretation into text, including models obtained by combining an LLM and a vision transformer (ViT) configured to create image embeddings of the visual information.

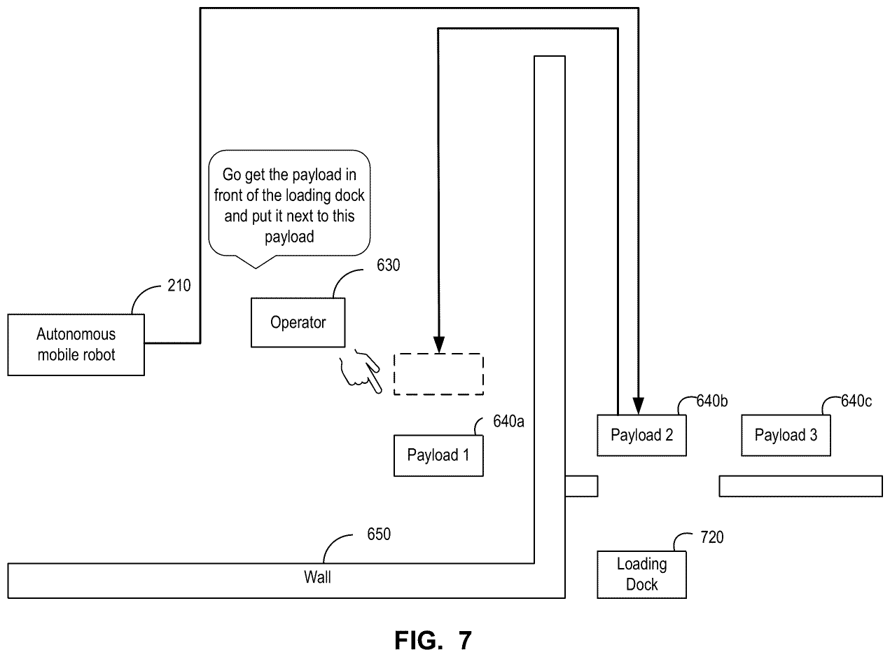

As explained, the user prompts can include a combination of different types of instructions. For example, the user prompts can include spoken instructions and a gesture or a demonstration. An example user prompt given by a human operator can include the spoken phrase “Go get the payload in front of the loading dock and put it next to this payload”, and the operator 630 pointing at a payload 640a as shown in FIG. 7. Another example user prompt can include the spoken phrase “Pick up this payload exactly like this”, the operator 630 pointing at a indicating a payload and performing a demonstration. The autonomous mobile robot 210 can process the different types of instructions to understand the mission instructions. In some embodiments, the autonomous mobile robot 210 converts each type of instruction into text and the text instructions can be processed by the autonomous mobile robot 210 to combine the instructions to understand the mission instructions. Alternatively, or in addition thereto, the autonomous mobile robot 210 can convert the mission instructions into a common representation (e.g., common programming language, domain-specific language and/or abstract tokens) and process the mission instructions in the common representation.

In some embodiments, the autonomous mobile robot 210 can process each type of instruction using a language encoder model to obtain a text embedding of the instruction and employ domain-specific encoding models to extract a semantically grounded embedding from each type of instruction. The text embedding and the semantically grounded embedding can be processed by a deep learning model (e.g., LLM, VLM, ALM) to understand the mission instructions. The autonomous mobile robot 210 can use context fusion to determine the relationship between the different types of instructions and fuse the different types of instructions.

In some embodiments, the user prompts can include instructions characterizing the manner in which the mission is to be performed. For example, the user prompts can include instructions to avoid certain areas of the facility (e.g., high traffic areas).

At 406, the autonomous mobile robot 210 determines an operational purpose of the autonomous mobile robot 210. For example, the robot processor 212 can be configured to determine an operational purpose of the autonomous mobile robot 210. In some embodiments, the operational purpose of the autonomous mobile robot 210 can be retrieved, for example from the external data storage 140. The operational purpose of the autonomous mobile robot 210 can define the purpose of the autonomous mobile robot 210, for example, a reason for which the autonomous mobile robot 210 is deployed within a facility and can include skills that can be performed by the autonomous mobile robot 210 (e.g., execute a docking step, recharge battery, search a map, ask for help), actions that can be performed by the autonomous mobile robot (e.g., drive forward, reverse, raise lift, flash lights, plan path, honk horn), operational constraints of the autonomous mobile robot 210 (e.g., geometric constraints imposed by the shape and size of the autonomous mobile robot 210, weight limits, velocity limits, collision avoidance capabilities, compatible payloads). In some embodiments, the operational purpose can include previously generated missions and/or missions preconfigured for the autonomous mobile robot 210. For example, missions that are frequently performed by an autonomous mobile robot 210 can be preconfigured for the autonomous mobile robot 210. The autonomous mobile robot 210 can retrieve previously generated missions and/or preconfigured missions upon determining that the mission goal can be accomplished by a preconfigured mission or a previously generated mission or that a previously generated mission or preconfigured mission can be modified to accomplish the mission goal of the autonomous mobile robot 210. The operational purpose of the autonomous mobile robot 210 can constrain the mission goal of the autonomous mobile robot 210 and/or the mission plan for accomplishing the goal, as will be explained in further detail below.

Though steps 402, 404 and 406 are shown in sequential order, it will be understood that steps 402, 404 and 406 need not be carried out in the order shown and can be carried out in any order, including simultaneously. For example, the autonomous mobile robot 210 can determine its operational purpose prior to receiving user prompts representative of mission instructions. As another example, the autonomous mobile robot 210 can collect environmental data and receive user prompts at the same time.

At 408, the autonomous mobile robot 210 initiates a planning component to evaluate the user prompts to define a mission goal for the autonomous mobile robot 210. For example, the robot processor 212 can implement a planning component that can evaluate the user prompts. The mission goal can be defined with reference to the operational purpose of the autonomous mobile robot 210, determined at 406 and the environmental data collected. For example, based on the operational purpose determined at 406, the autonomous mobile robot 210 may determine its capabilities and based on its capabilities, the autonomous mobile robot 210 can define a mission goal that does not exceed the autonomous mobile robot's capabilities. For example, an autonomous mobile robot 210 used for picking up and dropping off payloads may determine that its mission goal involves picking up and/or dropping off a payload. As another example, based on the environmental data collected, the autonomous mobile robot 210 may identify that an object in its vicinity is an object of interest (e.g., payload) and determine that the mission goal involves engaging with the object of interest (e.g., picking up the payload). As a further example, the autonomous mobile robot 210 can determine that it is a material transport robot capable of carrying a load having maximum dimensions W×L×H, determine that multiple payloads are in its vicinity but only one has dimensions smaller than W×L×H and determine that the mission goal involves picking up the smaller payload.

In some embodiments where the operational purpose includes previously generated missions and/or missions preconfigured for the autonomous mobile robot 210, the autonomous mobile robot 210 can analyze the previously generated missions and/or preconfigured missions to define the mission goal. For example, the autonomous mobile robot 210 can define a mission goal that is in accordance (e.g., not incompatible with, similar to, having similar constraints) with previously generated mission and/or preconfigured missions.

As a further example, the autonomous mobile robot 210 can determine that multiple payloads are in its vicinity but that some payloads are in an area that the autonomous mobile robot 210 cannot enter due to physical constraints and determine that only those payloads that are outside the area are payloads of interest. As another example, the autonomous mobile robot 210 can determine that multiple payloads are in its vicinity but that some payloads are not compatible (e.g. due to their height, form factor, stability, the manner in which the payloads need to be picked up) with the autonomous mobile robot 210 and determine that only those payloads that are compatible with the autonomous mobile robot 210 are payloads of interest.

As a further example, the autonomous mobile robot 210 can be an autonomous mobile robot used for transporting specific payloads and define a mission goal that only involves transporting those specific payloads.

In at least some embodiments, the autonomous mobile robot 210 employs one or more model(s) for interpreting the user prompts, the operational purpose and the environmental data to define the mission goal. For example, the autonomous mobile robot 210 can use one or more deep learning models (e.g., LLMs, VLMs and/or ALMs) depending on the nature of the user prompts received. The models can be trained to interpret language, auditive information and/or visual information to understand an intent of the user prompts and the environmental data and the operational purpose can be used to determine a context of the user prompts. The models can be trained to combine the context, based on the environmental data and the user prompts received to define the mission goal. That is, the models can be trained to understand an intent and meaning of the user prompts with reference to the environmental data and the operational purpose of the autonomous mobile robot 210 and define a mission goal in accordance with these. The models can be trained to interpret the semantic embeddings of the user prompts, the environmental data and the operational purpose to define the mission goal. For example, the user prompts, the environmental data and the operational purpose can be processed by the autonomous mobile robot 210 using encoding models to obtain semantic embeddings.

In some embodiments, each of the operational purpose, the environmental data and the user prompts is provided as one or more prompts to the large models. The large models can be trained to determine a mission goal with reference to the prompts.

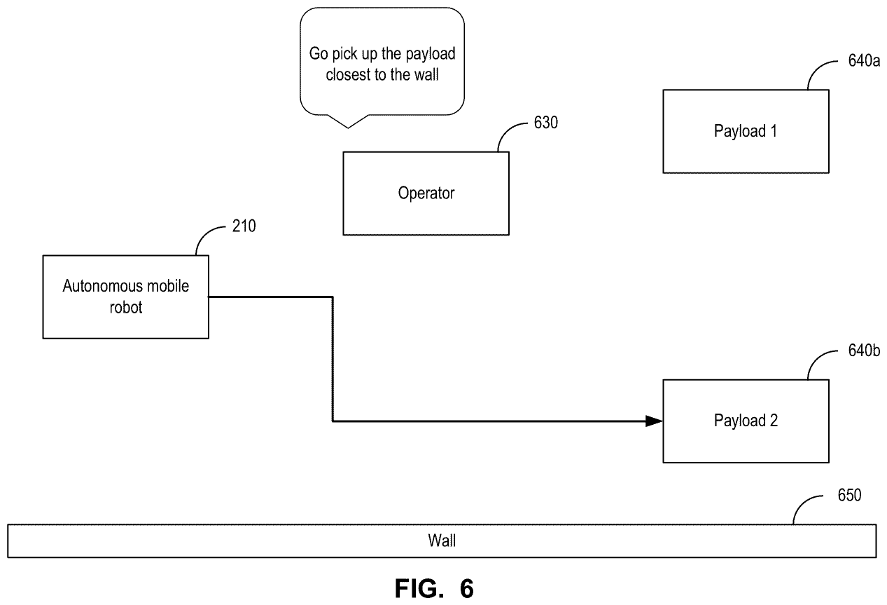

At 410, the autonomous mobile robot 210 generates a mission plan for accomplishing the mission goal via the planning component. The mission plan can define a path for the autonomous mobile robot 210 that is expected to enable the autonomous mobile robot 210 to accomplish its mission goal. For example, as shown in FIG. 6, to accomplish a mission goal involving picking up a payload closest to the wall 650, the autonomous mobile robot 210 can plan a path that allows the autonomous mobile robot 210 to travel to payload 640b. In at least some embodiments, the mission plan further includes tasks performed by the autonomous mobile robot 210. For example, in the example of FIG. 6, the mission plan can involve navigating to payload 640b, docking at a P&D stand of payload 640b and lifting off payload 640b.

The mission plan and/or the associated mission goal can be saved in memory, for example in the robot data storage 214 or the external data storage 140 for future retrieval by the autonomous mobile robot 210 or other autonomous mobile robots 210. For example, in cases where it is desirable for an autonomous mobile robot 210 to perform the same task multiple times and where the environment of the autonomous robot mobile 210 does not change rapidly, the autonomous mobile robot 210 can save the mission plan and/or mission goal and retrieve the mission plan and/or goal at a later time.

In some embodiments, for example, when autonomous mobile robots 210 operating within a facility have different operational purposes, the autonomous mobile robot 210 extracts an objective from the mission goal and can save the objective. The objective can then be retrieved by other autonomous mobile robots 210 and combined with each autonomous mobile robot's 210 operational purpose and environmental data to define a mission goal.

In some embodiments, the autonomous mobile robot 210 can retrieve an electronic map of the facility and the mission plan can be generated with reference to the electronic map. The electronic map can be retrieved from storage, for example, from external data storage 140 or can be received from the fleet management system 120. The electronic map can be a map characterizing the operating environment of the autonomous mobile robot 210 and can be generated based on environmental data collected by the autonomous mobile robot 210 or other autonomous mobile robots 210 prior to the autonomous mobile robot 210 retrieving the electronic map. In such embodiments, the autonomous mobile robot 210 can combine information from the electronic map and environmental data to define the mission goal and/or generate the mission plan. For example, the autonomous mobile robot 210 can use environmental data collected by the sensors of the autonomous mobile robot 210 to assess the immediate environment of the autonomous mobile robot 210 and information from the electronic map to assess the non-immediate environment (e.g., portions of the facility that are not within the view of the sensors of the autonomous mobile robot 210) of the autonomous mobile robot 210.

As another example, based on knowledge gained from the electronic map about its operating environment, the autonomous mobile robot 210 can define its mission goal and/or generate a mission plan (e.g., a mission plan avoiding non-traversable areas or hazard areas).

As described above, the electronic map can be semantically embedded, and the autonomous mobile robot 210 can define the mission goal and/or generate the mission plan with reference to the semantic embeddings. For example, the autonomous mobile robot 210 can use the electronic map to define the mission goal when a user prompt includes a reference to a location or a landmark within the facility (e.g., a loading dock station, a pick-up and drop-off location) or a relative position (e.g., in front of, behind, above, etc.).

In the example of FIG. 7, for example, the autonomous mobile robot 210 may employ an electronic map of the facility to define a path for the autonomous mobile robot 210 to travel to payload 640b, which is not within the immediate environment of autonomous mobile robot 210. In the example of FIG. 7, the autonomous mobile robot 210 can determine that the operator 630 has indicated to pick up the payload that is in front of the loading dock 720 and drop it off next to the payload 640a that is to the right of the autonomous mobile robot 210. The autonomous mobile robot 210 can determine that it cannot see the loading dock but that the electronic map indicates that there is a loading dock on the other side of the wall 650, that there are two payloads on the other side of the wall 650, payload 640b and 640c, and that there is a P&D stand directly in front of the loading dock. The autonomous mobile robot 210 can then determine that beside the pallet that is in front of the autonomous mobile robot 210, there is an empty P&D stand. The autonomous mobile robot 210 can then generate a mission plan that involves driving to the payload 640b, docking at the P&D stand associated with payload 640b, lift off payload 640b, drive to the empty P&D stand, dock at the empty P&D stand and drop off payload 640b.

In some embodiments, the autonomous mobile robot 210 can communicate a robot response that includes the mission plan and/or the autonomous mobile robot's 210 understanding of the mission goal. For example, the autonomous mobile robot 210 can provide a description of the autonomous mobile robot's 210 understanding of the mission goal and/or the path planned by the autonomous mobile robot 210.

The autonomous mobile robot 210 can communicate the robot response using the communications system 240. For example, the autonomous mobile robot 210 can use speakers mounted on the autonomous mobile robot 210 to emit audio signals, lights mounted on the autonomous mobile robot 210 to emit light signals (e.g., flashing lights, light pattern) or scent generators mounted on the autonomous mobile robot 210 to emit scents. The audio signals can be in the form of alerts or can be speech, for example, the autonomous mobile robot 210 may employ a speech synthesis algorithm to enable the autonomous mobile robot 210 to communicate with an operator using natural language. As another example, the autonomous mobile robot 210 may be equipped with a digital screen and display a written message on the digital screen and/or a map of the facility, indicating the path planned by the autonomous mobile robot 210 and/or objects of interest (e.g., payloads, obstacles) along the path planned by the autonomous mobile robot 210.

FIG. 6, for example, shows an autonomous robot 210 receiving user prompts from a human operator 630 and generating a mission plan. In response to user prompt “Go pick up the payload closest to the wall”, the autonomous mobile robot 210 can communicate one or more of the following statements: (1) The user indicated to pick up the payload closest to the wall. (2) Two payloads (640a, 640b) on pick-up and drop-off (P&D) stands and one wall (650) are currently in view. (3) The payload to my right (640b) is a closer distance to the wall (650). (4) I understand my mission to be to pick up the payload (640b) currently to my right. (5) I will drive to this payload (640b), dock to the P&D stand and lift off the payload (640b). FIG. 6 shows the mission plan generated by the autonomous mobile robot 210.

As another example, in some embodiments, the autonomous mobile robot 210 may be configured to perform gestures and/or motions. For example, the autonomous mobile robot 210 may be configured to perform small motions to indicate its intended direction. In some embodiments, the autonomous mobile robot 210 can communicate the robot response using a combination of the communications system and motions (e.g., a combination of blinking lights and wiggling from side to side).

In some embodiments, the autonomous mobile robot 210 can save the robot's response in memory, for example, in the robot data storage 214 or the external data storage 140 for future retrieval by the autonomous mobile robot 210 and/or other autonomous mobile robots 210 and can be used to define future mission goals and/or to generate future mission plans.

By communicating the autonomous mobile robot's 210 mission plan and/or understanding of the mission goal, the autonomous mobile robot 210 can provide feedback to a human operator, who can provide additional user prompts if needed, for example, if the human operator determines that the autonomous mobile robot's 210 understanding of the mission is incorrect or needs further refinement. The autonomous mobile robot 210 can evaluate the user prompts received at 404 and any additional user prompts to redefine the mission goal and the re-generate a mission plan. The process can be repeated until no further user prompts are received.

In some embodiments, when the autonomous mobile robot 210 determines that the autonomous mobile robot 210 has insufficient information to generate the mission plan, requires additional information to generate the mission plan or is otherwise unable to generate the mission plan, the autonomous mobile robot 210 can generate a request, for example, a request for additional information.

The request for additional information can be a natural language request. For example, the autonomous mobile robot 210 can communicate a request for additional information to the operator, using the robot communications system 240. The request for additional information can be a text request displayed on a display screen of the autonomous mobile robot 210, an audio request communicated using speakers mounted on the robot communications system. Alternatively, the request can be transmitted to an external device, for example, a computing device associated with an operator. For example, the autonomous mobile robot 210 may transmit a text or audio request via a network, for example, network 130 to an external computing device.

Alternatively, or in addition thereto, the request can include a request to search an electronic map of the facility. For example, the electronic map of the facility may be updated as other autonomous mobile robots 210 execute other missions within the facility.

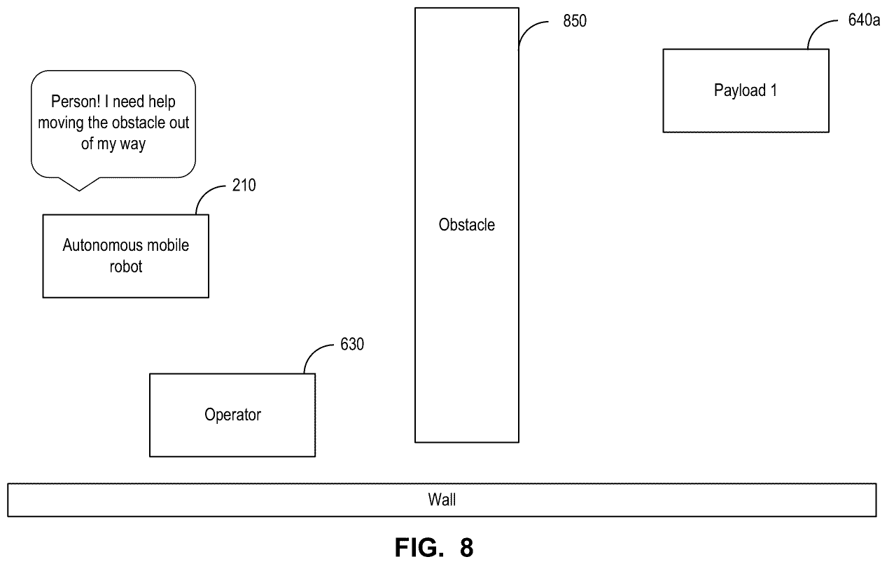

In some embodiments, the request can be a request for help, for example, as shown in FIG. 8, the autonomous mobile robot 210 can determine that its mission goal is to pick up payload 640a. However, the autonomous mobile robot 210 can determine, based on environmental data, that it is unable to navigate over to payload 640a due to obstacle 850, for example, because there is insufficient space for the autonomous mobile robot 210 to navigate around obstacle 850 to pick up payload 640a. In such embodiments, the autonomous mobile robot 210 can request assistance from the operator 630.

At 402, the autonomous mobile robot 210 initiates an execution component to operate the autonomous mobile robot 210 to execute the mission plan. For example, the robot processor 212 and/or the safety processor 218 can operate the drive system 230 to navigate to waypoints or a destination location as indicated by the mission plan and perform tasks associated with the mission (e.g., dock at a station, pick up load, lift off load, drop off load). The execution component is functionally separate from the planning component. By functionally separating the execution component from the planning component, each component can dedicate its resources to specific tasks and can be trained separately.

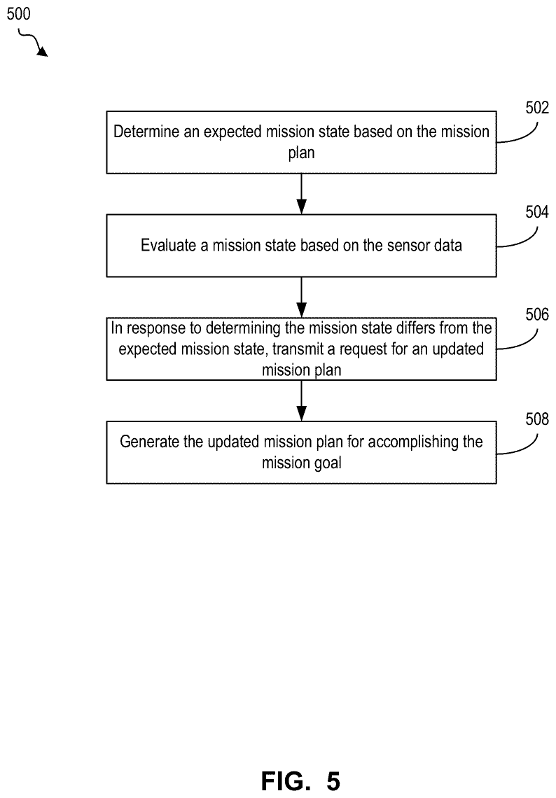

As the autonomous mobile robot 210 is executing the mission plan, the autonomous mobile robot 210 can monitor the execution of the mission plan, via an execution monitoring component. FIG. 5, for example, shows a flowchart of an example method 500 for monitoring the execution of a mission plan. The steps of method 500 can be performed by one or more processors of the autonomous mobile robot 210, for example, robot processor 212. To monitor the execution of the mission plan, the autonomous mobile robot 210 can continuously monitor the environmental data collected by the sensors of the autonomous mobile robot 210 as the autonomous mobile robot 210 is executing the mission plan.

At 502, the autonomous mobile robot 210 determines an expected mission state of the autonomous mobile robot 210, based on the mission plan. The expected mission state can include but is not limited to, an expected environment of the autonomous mobile robot 210, an expected location of the autonomous mobile robot 210, progress of the autonomous mobile robot 210 towards completion of the mission, etc. For example, based on the mission plan and the path navigated by the autonomous mobile robot 210, the autonomous mobile robot 210 can determine that the environment of the autonomous mobile robot 210 is expected to be free from obstacles.

At 504, the autonomous mobile robot 210 evaluates the current mission state, based on the environmental data collected by the sensors. The current mission state can for example, define the current environment, location, progress, etc.

At 506, the autonomous mobile robot 210 determines whether the current mission state is consistent with the expected mission state and in response to determining that the current mission state and the expected mission state differ, the autonomous mobile robot 210 transmits a request for an updated mission plan. For example, while executing a mission plan, the autonomous mobile robot 210 may encounter an obstacle that was not detected by the autonomous mobile robot 210 prior to mission plan generation and/or that was not present in the electronic map received by the autonomous mobile robot 210.

Upon transmitting the request for an updated mission plan, the autonomous mobile robot 210 can, in some cases, pause the mission. For example, when the autonomous mobile robot 210 determines that it is not able to continue executing the mission plan due to the expected mission state differing from the current mission state, the autonomous mobile robot 210 can come to a stop.

At 508, the autonomous mobile robot 210 generates an updated mission plan that accomplishes the mission goal determined at 408 of method 400 via the planning component, based on the current environmental data collected by the autonomous mobile robot 210. By generating an updated mission plan that accomplishes the mission goal, the autonomous mobile robot 210 can identify alternate paths for completing the mission goal and avoid aborting the mission. Unlike conventional autonomous mobile robots, the autonomous mobile robots 210 can avoid abandoning a mission when an original path is not feasible.

In some embodiments, while the autonomous mobile robot 210 is executing a mission plan, the autonomous mobile robot 210 can predict future mission conflicts between the autonomous mobile robot 210 and other autonomous mobile robots or other actors within the facility (e.g., operator, movable equipment, custodian) based on environmental data collected by the sensors (e.g., visual cues, auditive cues) of the autonomous mobile robot 210, information received from other autonomous mobile robots, from the fleet management system 120, from an operator, or a combination of these. For example, the autonomous mobile robot 210 can determine that its mission plan is likely to conflict with another autonomous mobile robot's 210 mission plan (e.g., there may be a risk of collision). In such cases, the autonomous mobile robot 210 can evaluate its mission goal and/or mission plan, determine the mission plan of the other autonomous mobile robot 210 and evaluate the priority of its mission relative to the mission of the other autonomous mobile robot 210. Alternatively, the autonomous mobile robot 210 can receive a priority level of the other autonomous mobile robot (e.g., from the fleet management system 120, from an operator and/or from the other autonomous mobile robot 210).

Information about the priority of another autonomous mobile robot's mission can be received as direct information (e.g., autonomous mobile robot X has a higher priority) or as indirect information (e.g., autonomous mobile robots of type Y have a higher priority). The priority can be a current priority (e.g., priorities can vary overtime). Based on its evaluation of priorities, the autonomous mobile robot 210 can continue executing its mission plan, pause execution of its mission plan, or request an updated mission plan from the planning component.

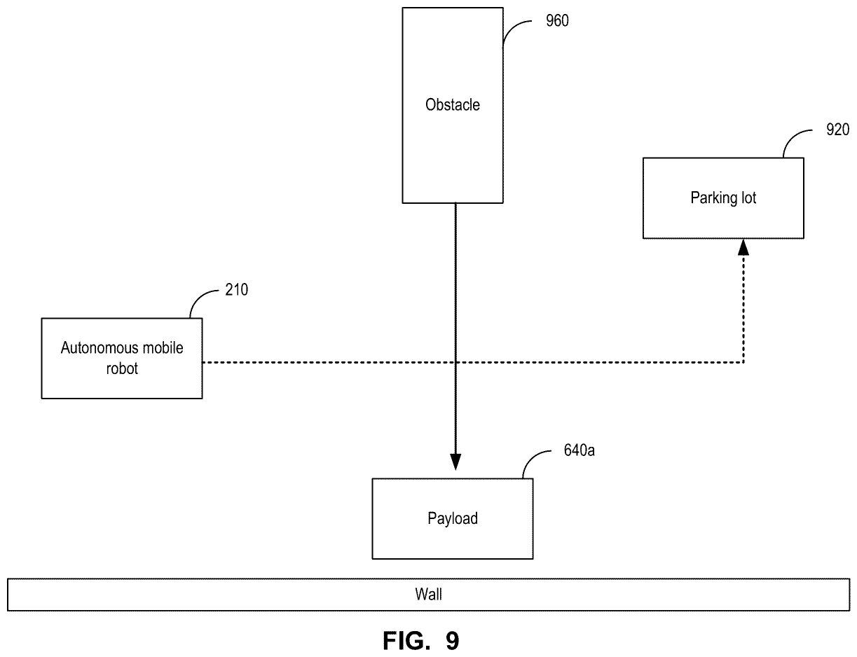

FIG. 9 for example, shows an example of predicted future mission conflict between the autonomous mobile robot 210 and a human-operated forklift 960. In the example shown, the autonomous mobile robot's 210 mission involves navigating to parking lot 920 and shutting down for the day. The autonomous mobile robot 210 determines that the forklift's 960 mission involves picking up a payload 640a, that the forklift's 960 mission has a higher priority than its own mission and that waiting until the forklift 960 has completed its mission is the course of action to follow.

In some embodiments, the autonomous mobile robot 210 can communicate with the other actor using the robot communications system 240 and/or transmit a communication to an external computing device via network 130 to notify the operator of the predicted future mission conflict and course of action determined by the autonomous mobile robot 210.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to above as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

We claim:

1. An autonomous mobile robot operable within a facility comprising:
one or more sensors configured to:
collect environmental data characterizing an environment of the autonomous mobile robot; and
receive user prompts representative of mission instructions, the user prompts comprising natural directions; and
one or more processors in communication with the one or more sensors, the one or more processors being configured to:
determine an operational purpose of the autonomous mobile robot;
initiate a planning component to:
evaluate the user prompts to define a mission goal for the autonomous mobile robot with reference to the operational purpose of the autonomous mobile robot and the environmental data; and
generate a mission plan for accomplishing the mission goal, the mission plan defining a path for the autonomous mobile robot; and
initiate an execution component functionally separate from the planning component to operate the autonomous mobile robot to execute the mission plan.

2. The autonomous mobile robot of claim 1, wherein the plurality of sensors are configured to continuously monitor the environmental data and wherein the one or more processors are configured to:
initiate an execution monitoring component to, while the autonomous mobile robot is operating to execute the mission plan:
determine an expected mission state based on the mission plan; and
evaluate a current mission state of the autonomous mobile robot based on the environmental data; and
in response to determining the current mission state differs from the expected mission state, transmit a request for an updated mission plan,
wherein the planning component is configured to generate the updated mission plan for accomplishing the mission goal, based on the environmental data.

3. The autonomous mobile robot of claim 1, wherein the user prompts comprise one or more of: verbal instructions, visual instructions, and a demonstration.

4. The autonomous mobile robot of claim 1, wherein the operational purpose comprises one or more of: operational constraints of the autonomous mobile robot, skills performable by the autonomous mobile robot, actions performable by the autonomous mobile robot, previously generated mission plans and pre-configured mission plans.

5. The autonomous mobile robot of claim 1, the one or more processors being configured to:
retrieve an electronic map of the facility characterizing previous environmental data; and
generate the mission plan based on the electronic map.

6. The autonomous mobile robot of claim 1, the one or more processors being configured to:
in response to determining insufficient information is available to generate a mission plan, generate a natural request for additional information.

7. The autonomous mobile robot of claim 1, the one or more processors being configured to:
generate a natural language robot response describing the mission plan.

8. The autonomous mobile robot of claim 1, wherein the autonomous mobile robot comprises a digital screen configured to display an electronic map of the facility indicating one or more of: the path of the autonomous mobile robot and objects of interest along the path of the autonomous mobile robot.

9. The autonomous mobile robot of claim 1, the one or more processors being configured to, while the autonomous mobile robot is executing the mission plan:
identify future mission conflicts between the mission plan of the autonomous mobile robot and a mission plan of another actor within the facility based on the environmental data;
determine a priority of the mission goal associated with the mission plan of the other actor, relative to a priority of the mission goal of the autonomous mobile robot; and
determine a course of action, based on the priority of the mission goal of the other actor relative to the priority of the mission goal of the autonomous mobile robot.

10. The autonomous mobile robot of claim 9, wherein the course of action is one of: requesting an updated mission plan, continuing execution of the mission plan and pausing execution of the mission plan.

11. A method of operating an autonomous mobile robot comprising one or more sensors, the method comprising:
collecting, by the sensors, environmental data characterizing an environment of the autonomous mobile robot;
receiving, by the sensors, user prompts representative of mission instructions, the user prompts comprising natural directions; and
operating one or more processors to:
determine an operational purpose of the autonomous mobile robot;
initiate a planning component to:
evaluate the user prompts to define a mission goal for the autonomous mobile robot with reference to the operational purpose of the autonomous mobile robot and the environmental data; and
generate a mission plan for accomplishing the mission goal, the mission plan defining a path for the autonomous mobile robot; and
initiate an execution component functionally separate from the planning component to operate the autonomous mobile robot to execute the mission plan.

12. The method of claim 11, further comprising:
continuously monitoring, by the sensors, the environmental data,
and wherein the method further comprises operating the one or more processors to:
initiate an execution monitoring component to, while the autonomous mobile robot is operating to execute the mission plan:
determine an expected mission state based on the mission plan; and
evaluate a current mission state of the autonomous mobile robot based on the environmental data;
in response to determining the current mission state differs from the expected mission state, transmit a request for an updated mission plan, and
wherein the planning component is configured to generate the updated mission plan for accomplishing the mission goal, based on the environmental data.

13. The method of claim 11, wherein the user prompts comprise one or more of: verbal instructions, visual instructions, and a demonstration.

14. The method of claim 11, wherein the operational purpose comprises one or more of: operational constraints of the autonomous mobile robot, skills performable by the autonomous mobile robot, actions performable by the autonomous mobile robot, previously generated mission plans and pre-configured mission plans.

15. The method of claim 11, further operating the one or more processors to:
retrieve a facility map of the facility characterizing previous environmental data; and
generate the mission plan based on the facility map.

16. The method of claim 11, further operating the one or more processors to:
in response to determining insufficient information is available to generate a mission plan, generate a natural request for additional information.

17. The method of claim 11, further operating the one or more processors to:
generate a natural language robot response describing the mission plan.

18. The method of claim 11, wherein the autonomous mobile robot comprises a digital screen and the method comprises configuring the digital screen to display an electronic map of the facility indicating one or more of: the path of the autonomous mobile robot and objects of interest along the path of the autonomous mobile robot.

19. The method of claim 11, further operating the one or more processors to, while the autonomous mobile robot is executing the mission plan:
identify future mission conflicts between the mission plan of the autonomous mobile robot and a mission plan of another actor within the facility based on the environmental data;
determine a priority of the mission goal associated with the mission plan of the other actor, relative to a priority of the mission goal of the autonomous mobile robot; and
determine a course of action, based on the priority of the mission goal of the other actor relative to the priority of the mission goal of the autonomous mobile robot.

20. The method of claim 19, wherein the course of action is one of: requesting an updated mission plan, continuing execution of the mission plan and pausing execution of the mission plan.
